(19) United States
(12) Patent Application Publication
(10) Pub. No.: US 2026/0211226 A1
(43) Pub. Date: Jul. 23, 2026

(54) Night vision binoculars

(71) Applicant: THALES, Meudon (FR)

(72) Inventor: Gabriel NARCY, SAINT HEAND (FR)

(21) Appl. No.: 19/137,861

(22) PCT Filed: Dec. 13, 2023
(86) PCT No.: PCT/EP2023/085634

§ 371 Date: Jun. 11, 2025

(30) Foreign Application Priority Data
Dec. 13, 2022 (FR) FR2213233

(51) Int. Cl. G02B 23/12; G02B 23/02

(52) U.S. Cl. CPC G02B 23/12; G02B 23/02

(57) ABSTRACT

Night vision binoculars including at least two optical units each having an optical axis, and a harmonization device of the optical axes of the two optical units, the harmonization device including two prismatic optical blades permanently locked in rotation and oriented relative to each other and relative to the optical units such that the optical axes of the at least two optical units are parallel.

### CROSS-REFERENCE TO RELATED APPLICATIONS

This application claims benefit under 35 USC § 371 of PCT Application No. PCT/EP2023/085634 entitled NIGHT VISION BINOCULARS, filed on Dec. 13, 2023 by inventor Gabriel Narcy, PCT Application No. PCT/EP2023/085634 claims priority of French Patent Application No. 22 13233, filed on Dec. 13, 2022.

### FIELD OF THE INVENTION

The present invention relates to night vision binoculars.

It more particularly relates to harmonization devices for harmonizing axes between the optical paths of night vision binoculars.

### BACKGROUND OF THE INVENTION

The performance of parallelism (collimation, convergence, divergence, supravergence) of night vision binoculars directly contribute to the viewing comfort of the user and allows to ensure that the binoculars alter the right/left eye image overlay capability as little as possible and generate minimal eye fatigue over time.

According to the user typologies addressed, the needs for optical axis harmonization expressed through these parallelism performances are more or less severe (harmonization of less than 1° for low-performance applications, and less than 0.5° or even 0.3° for high-performance applications).

In the field of night vision binoculars, various hands-free devices exist. They all present a magnification of ×1 and require optical axis harmonizations (also called optical invariant for ×1 magnification systems) between the different optical inlet and outlet to avoid disturbing user senses (orientation and viewing comfort). In particular:
monocular devices, where the user looks through an optical system with one eye, require precise optical axis harmonization between the objective inlet and the eyepiece outlet.
bi-ocular devices, where the user views an intensified image captured by a single objective with both eyes, require precise optical axis harmonization between the right and left eyepiece outlet.
binocular devices, where the user looks through two independent optical paths each comprising an intensifier tube, require precise optical axis harmonization between the two paths. In this case, the user has a stereoscopic view of the observed scene.
panoramic devices, also called “quad-eyes,” where the user looks through four intensified paths (2 central paths and 2 lateral paths) require both precise optical axis harmonization between the two central paths, as well as precise axis harmonization between the central and lateral left, respectively right paths.

Classically available binoculars on the market offer a standard field of 40° for a numerical aperture of F/1.2. The night vision binoculars market is evolving toward increasing fields and numerical aperture without loss of resolution while reducing the equipment mass. This evolution leads to proposing much more complex optical architectures and makes the relative positioning of optics of one relative to another more sensitive.

However, the solutions identified in the known state of the art proposing internal adjustment devices in the binoculars are difficult to implement on new wide field and/or large numerical aperture optics:
They require increasingly precise and stable mechanisms in thermal and mechanical environments.
They can generate loss of optical quality (resolution/MTF/distortion) when the displacement of the optic, favorable to axis alignment, generates optical aberrations.
They can lead to iterative adjustment strategies requiring phases of dismantling and reassembly of the binoculars.

There is therefore a need for an optical axis harmonization solution for night vision binoculars, simple to implement, not degrading image quality, and applicable to all types of night vision binoculars, especially new-generation binoculars presenting more complex optics with expanded field and numerical aperture.

### SUMMARY OF THE DESCRIPTION

To this end, the present description has as its object night vision binoculars comprising:
a. at least two optical units each having an optical axis, and
b. a harmonization device for harmonizing the optical axes of the two optical units, the harmonization device comprising two prismatic optical blades permanently locked in rotation and oriented one relative to the another and to the optical units so that the optical axes of the at least two optical units are parallel.

According to particular embodiments, the binoculars comprise one or more of the following features, taken alone or according to any technically possible combination:
the two optical blades are fixed to each other, preferably by gluing;
the two optical blades are mounted in a same barrel;
the two optical units belong to different optical paths, one optical blade of the harmonization device being positioned on the optical path of one of the optical units, and the other optical blade of the harmonization device being positioned on the optical path of the other optical unit;
the two optical blades are inclined at the same non-zero angle relative to the normal to the optical axis of one of the optical units;
at least one of the optical units comprises an objective, at least one optical blade of the harmonization device being positioned at the entrance of the objective of the or one of the optical units;
the binoculars are monocular so that the two optical units belong to the same optical path, one of the optical units being an eyepiece and the other optical unit being an objective;
the binoculars are biocular so that the two optical units belong to different optical paths, one of the optical units being a first eyepiece and the other optical unit being a second eyepiece;
the binoculars are binocular so that the two optical units belong to different optical paths, one of the optical units comprising a first eyepiece and a first objective, the other optical unit comprising a second eyepiece and a second objective;
the binoculars are panoramic with four optical paths from among: a right central path, a right lateral path, a left central path, and a left lateral path, the two optical units each comprising an eyepiece and an objective, the two optical units belonging to two different optical paths from among the following path combinations: the right central path and the right lateral path, the left central path and the left lateral path, and the two central paths, so that the harmonization device harmonizes the optical axes of the two optical paths of the combination;
the binoculars comprise two additional harmonization devices positioned on the optical paths of the other two combinations of optical paths to harmonize the optical axes of said optical paths.

The present description also has as its object a method for harmonizing the optical axes of two optical units of night vision binoculars, the harmonization method being implemented during the design of the binoculars, the method comprising:
a. measurement of a parallelism defect between the optical axes of the two optical units,
b. rotation of two prismatic optical blades one relative to the other and together so as to compensate for the measured parallelism defect,
c. permanent locking of the rotation of the two optical blades, and
d. positioning of the two prismatic optical blades on the optical path of at least one of the two optical units, the two optical blades forming a harmonization device for harmonizing the optical axes of the two optical units.

### BRIEF DESCRIPTION OF THE DRAWINGS

Other features and advantages of the invention will appear from the following description of embodiments of the invention, given by way of example only and with reference to the drawings which are:

FIG. 1, a schematic representation of an example of night vision binoculars comprising two optical units on a same optical path and a harmonization device for harmonizing the optical axes of the two optical units,

FIG. 2, a schematic representation of an example of night vision binoculars comprising two optical units on different optical paths and a harmonization device for harmonizing the optical axes of the two optical units,

FIG. 3, a schematic representation of an example of a harmonization device comprising two prismatic optical blades, the blades being oriented relative to each other so as not to induce optical axis deviation,

FIG. 4, a schematic representation similar to FIG. 3, relative to FIG. 3, one of the blades having been rotated 180° relative to the other blade to induce maximum axis deviation upward,

FIG. 5, a schematic representation similar to FIGS. 3 and 4, relative to FIG. 4, the two blades having been rotated together 180° so as to induce maximum axis deviation downward,

FIG. 6, a schematic representation of a barrel in which the two prismatic optical blades forming the harmonization device are inserted, and

FIG. 7, a schematic representation similar to FIG. 6, the two blades having been inclined relative to the normal to the optical axis of the optical unit receiving the harmonization device.

### DETAILED DESCRIPTION OF EMBODIMENTS

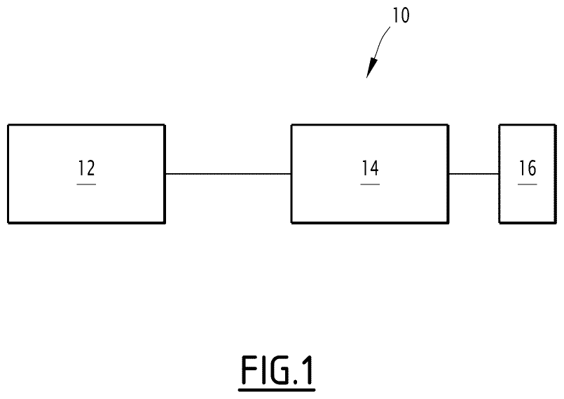

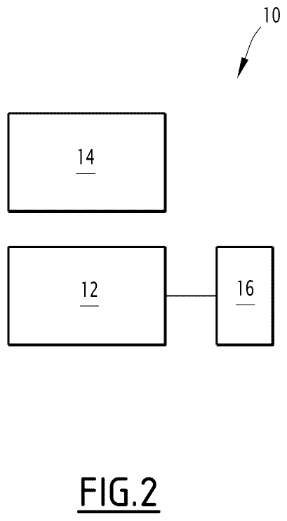

Night vision binoculars 10 are schematically illustrated in FIGS. 1 and 2.

The binoculars 10 are, for example, intended to be mounted on a helmet or head harness. Alternatively, the binoculars 10 are handheld by the user.

The night vision binoculars 10 are any type of night vision binoculars, notably monocular binoculars, bi-ocular binoculars, binocular binoculars, or even panoramic binoculars (4 intensified paths). The binoculars 10 can also be connected binoculars and integrate data visualization elements.

As illustrated by FIGS. 1 and 2, the binoculars 10 comprise at least two optical units 12, 14 each having an optical axis A1, A2, as well as a harmonization device 16 for harmonizing the optical axes A1, A2 of the two optical units 12, 14. The harmonization consists of making the two optical axes A1, A2 parallel.

In the example illustrated by FIG. 1, the two optical units 12, 14 belong to the same optical path. This is notably the case for monocular binoculars where one of the optical units 12, 14 is an eyepiece and the other optical unit 12, 14 is an objective.

In the example illustrated by FIG. 2, the two optical units 12, 14 belong to different optical paths. This is notably the case for biocular binoculars where one of the optical units 12, 14 is a first eyepiece and the other optical unit 12, 14 is a second eyepiece. The harmonization, thus, consists of making the optical axes A1, A2 of the two eyepieces parallel.

This is also the case for binocular binoculars where one of the optical units 12, 14 comprises a first eyepiece and a first objective and the other optical unit 12, 14 comprises a second eyepiece and a second objective. The harmonization, thus, consists of making the optical axes A1, A2 of the two optical paths parallel.

Finally, this is also the case for panoramic binoculars having four optical paths from among: a right central path, a right lateral path, a left central path, and a left lateral path. In this case, a first optical unit 12, 14 comprises the eyepiece and the objective of one of the paths, and the other optical unit 12, 14 comprises the eyepiece and the objective of another of the paths, from among the following combinations of optical paths: the right central path and the right lateral path, or the left central path and the left lateral path, or the two central paths. The harmonization, thus, consists of making the optical axes A1, A2 of the two optical paths of the combination parallel.

Preferably, in the case of panoramic binoculars, the binoculars 10 comprise two additional harmonization devices positioned on the optical paths of the other two combinations of optical paths to also harmonize the optical axes A1, A2 of said optical paths. Thus, the right paths are harmonized with each other, the left paths also, as well as the right and left central paths.

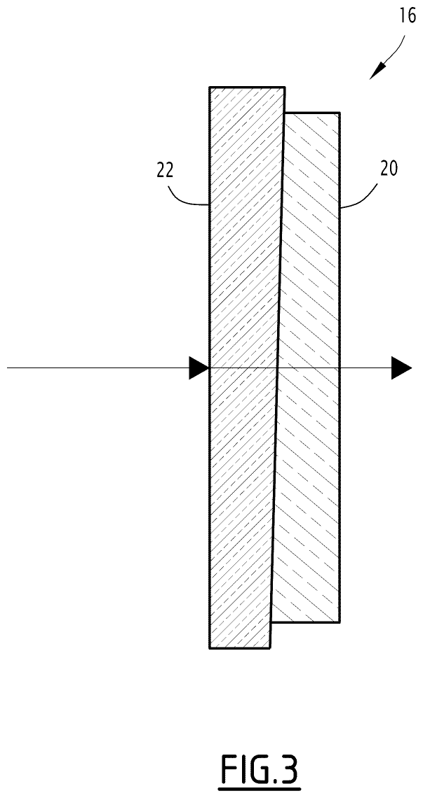

As illustrated in the examples of FIGS. 3 to 7, the harmonization device 16 comprises two prismatic optical blades 20, 22. The two optical blades 20, 22 preferably have the same prismatic angle. The two optical blades 20, 22, thus, form a diasporometer. The two optical blades 20, 22 are, for example, made of glass or polycarbonate.

Preferably, the prismatic effect induced by the two blades 20, 22 is weak, in other words, the total prismatic angle of the two blades 20, 22 is weak, typically less than 5 degrees, preferably less than or equal to 2 degrees.

The two optical blades 20, 22 are permanently locked in rotation. The user, thus, does not have the possibility to rotate the blades 20, 22. The two optical blades 20, 22 are, however movable, if necessary, in translation.

For example, the two optical blades 20, 22 are locked by being fixed to each other and inserted into the same barrel locked in rotation, or by being each inserted into a barrel locked in rotation.

The two optical blades 20, 22 have been previously oriented (during design) relative to each other and relative to the optical units 12, 14 so that the optical axes A1, A2 of the at least two optical units 12, 14 are parallel.

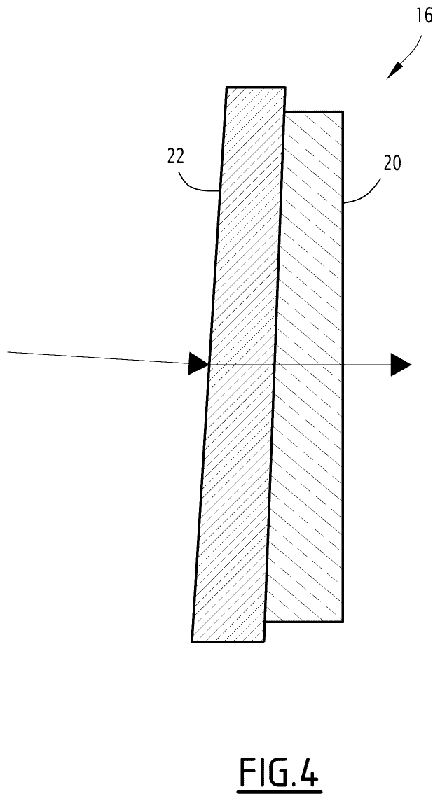

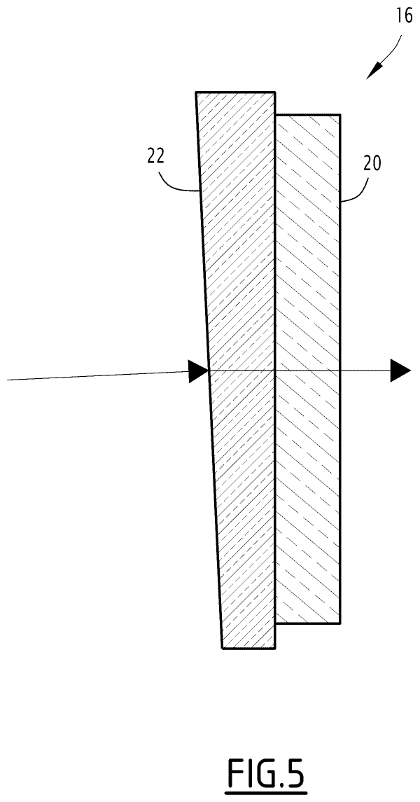

In particular, in the examples of FIGS. 3 to 5, FIG. 3 corresponds to an orientation of the two blades not introducing axis deviation. FIG. 4 corresponds to a rotation of the blade 20 by 180° relative to the configuration of FIG. 3, so as to induce maximum axis deviation upward. FIG. 5 corresponds to a rotation of the two blades together by 180° relative to the configuration of FIG. 4, so as to induce maximum axis deviation downward.

As illustrated in FIGS. 4 and 5, for blades with index n and for a prismatic angle of 0 for each blade, the maximum deviation angle is obtained when the 2 blades are facing each other. The prismatic angle is then 20 and the axis deviation is arc sin((n−1)*sin(2θ)).

In one embodiment, corresponding to FIGS. 3 to 7, the two optical blades 20, 22 are fixed to each other, and this permanently. For example, the two blades 20, 22 are fixed to each other by gluing. Preferably, the gluing is full-face in order to reduce the internal reflection coefficient in the diasporometer with the aim of limiting the level of parasitic images generated by multiple reflections on the faces of the blades.

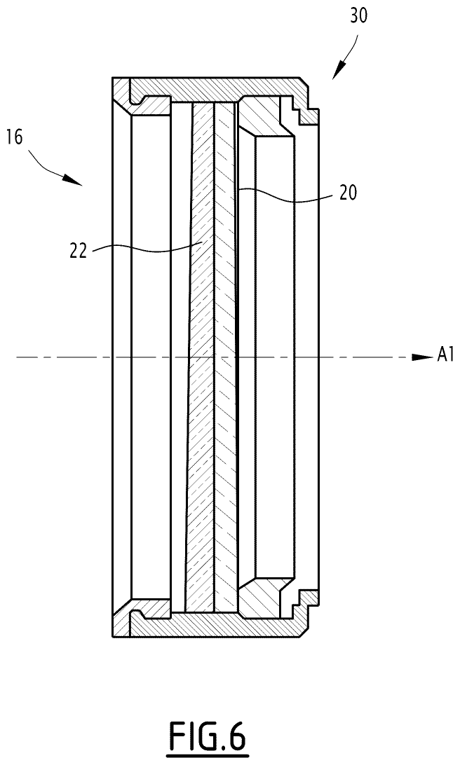

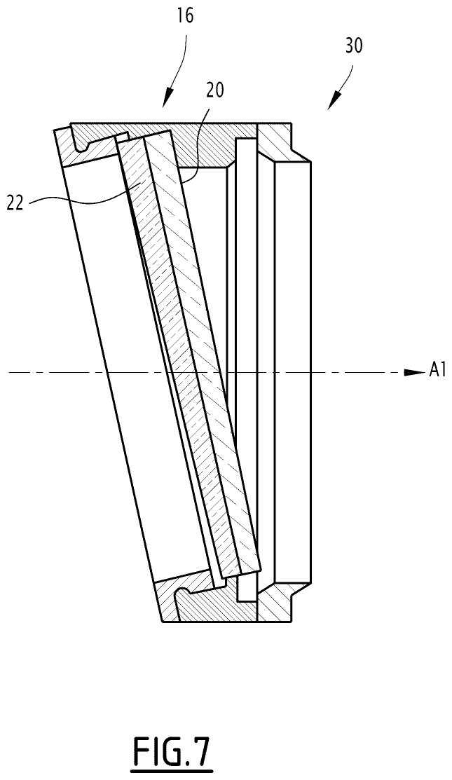

Preferably, the two optical blades 20, 22 are mounted in the same barrel 30, as is the case in FIGS. 6 and 7. The barrel 30 is indexed on the optical path on which it is positioned (centered on the optical axis of the path).

In another embodiment, the two optical units 12, 14 belong to different optical paths. In this case, one optical blade 20, 22 of the harmonization device 16 is positioned on the optical path of one of the optical units 12, 14, and the other optical blade 20, 22 of the harmonization device 16 is positioned on the optical path of the other optical unit 12, 14.

In one example of implementation, the two optical blades 20, 22 are inclined at the same angle relative to the normal to the optical axis of one of the optical units 12, 14. This allows decentering, or even shifting, out of the field any parasitic images due to the fixation (gluing) of the blades. Such an inclination is represented in FIG. 7.

Preferably, when at least one of the optical units 12, 14 comprises an objective (case of monocular, binocular, and panoramic binoculars), at least one optical blade 20, 22 of the harmonization device 16 is positioned at the inlet of the objective of the or of one of the optical units 12, 14. Advantageously, the two optical blades 20, 22 are positioned at the inlet of the objective of the or of one of the optical units 12, 14.

Preferably, the focusing mechanism of the objective (or objectives) of the binoculars 10 is said to be “by translation” so that the orientation of the axis deviation introduced by the diasporometer does not vary depending on the focus of the objective.

One example of a method for harmonizing the optical axes A1, A2 of two optical units 12, 14 of night vision binoculars 10 will now be described. Such a harmonization method is implemented during the design of the binoculars 10. The harmonization is then fixed so that the obtained parallelism is maintained during operation of the binoculars 10.

The harmonization method comprises measuring a parallelism defect between the optical axes A1, A2 of the two optical units 12, 14. Such a defect has an amplitude A and an orientation β relative to a coordinate system (X-Y). The correction to be applied to the diasporometer is the inverse of the measured defect.

Outside the binoculars 10, the two prismatic optical blades 20, 22 of the harmonization device 16 are rotated one relative to the other so as to compensate for the measured parallelism defect, in other words, to generate an axis deviation allowing to compensate for the measured parallelism defect. In particular, the correction amplitude is obtained by rotating one blade relative to the other. The axis correction orientation is obtained by rotating the two blade together.

The two optical blades 20, 22 are then permanently locked in rotation, for example, either by being fixed to each other and inserted into the same barrel 30 locked in rotation, or by being each inserted into a barrel locked in rotation.

The two blades 20, 22 are then positioned on the optical path of one of the optical units 12, 14 (case where the two blades are fixed to each other) or each on the optical path of a respective optical unit 12, 14.

Thus, the optical axis harmonization device 16 is simple to integrate into night vision binoculars. In addition, it does not degrade image quality. It is furthermore applicable to all types of night vision binoculars, notably new generation binoculars presenting more complex optics with expanded field and numerical aperture.

Furthermore, the proposed solution allows to externalize the harmonization adjustments between the optical paths. It thus allows the internal opto-mechanical designs of the binoculars to be simplified and to optimize tolerance balance by eliminating the need for axis adjustment by relative displacements of internal optical subassemblies in the binoculars.

The harmonization device 16 does not require precise mechanical positioning of the blades 20, 22 and advantageously replaces fine internal adjustment devices.

Since the adjustment is external, it avoids iterative adjustment strategies requiring dismantling and reassembly phases of the binocular bodies in the case of complex night vision binoculars and notably in the case of panoramic binoculars with 4 optical paths.

The skilled person will understand that the previously described embodiments and alternatives can be combined with each other provided they are technically compatible.

1. Night vision binoculars comprising:
at least two optical units each having an optical axis; and
a harmonizer harmonizing the optical axes of the of said at least two optical units, the harmonizer comprising at least two prismatic optical blades permanently locked in rotation and oriented one relative to another and to said at least two optical units so that the optical axes of said at least two optical units are parallel.

2. The binoculars according to claim 1, wherein said at least two optical blades are fixed to each other.

3. The binoculars according to claim 1, wherein said at least two optical blades are mounted in a same barrel.

4. The binoculars according to claim 1, wherein said at least two optical units belong to different optical paths, one optical blade of said harmonizer being positioned on the optical path of one of said at least two optical units, and another optical blade of said harmonizer being positioned on the optical path of another one of said at least two optical units.

5. The binoculars according to claim 1, wherein said at least two optical blades are inclined at the same non-zero angle relative to the normal to the optical axis of one of said at least two optical units.

6. The binoculars according to claim 1, wherein at least one of said at least two optical units comprises an objective, at least one optical blade of said harmonizer being positioned at the entrance of the objective or one of said at least two optical units.

7. The binoculars according to claim 1, wherein the binoculars are monocular so that said at least two optical units belong to the same optical path, one of said at least two optical units being an eyepiece and another of said at least two optical units being an objective.

8. The binoculars according to claim 1, wherein the binoculars are biocular so that said at least two optical units belong to different optical paths, one of said at least two optical units comprising a first eyepiece and another one of said at least two optical units comprising a second eyepiece.

9. The binoculars according to claim 1, wherein the binoculars are binocular so that said at least two optical units belong to different optical paths, one of said at least two optical units comprising a first eyepiece and a first objective, and another one of said at least two optical units comprising a second eyepiece and a second objective.

10. The binoculars according to claim 1, wherein the binoculars are panoramic with four optical paths from among a right central path, a right lateral path, a left central path, and a left lateral path, each of said at least two optical units comprising an eyepiece and an objective, said at least two optical units belonging to at least two different optical paths from among the following path combinations: the right central path and the right lateral path, the left central path and the left lateral path, and the two central paths, so that said harmonizer harmonizes the optical axes of the at least two optical paths of the combination.

11. The binoculars according to claim 10, wherein the binoculars comprise two additional harmonizers positioned on the optical paths of the other two combinations of optical paths so as to harmonize the optical axes of said at least two optical paths.

12. A method for harmonizing optical axes of two optical units of night vision binoculars, the method being implemented during design of the binoculars, the method comprising:
measuring a parallelism defect between the optical axes of the two optical units;
rotating two prismatic optical blades one relative to the other and together so as to compensate for the measured parallelism defect;
permanently locking rotation of the two optical blades; and
positioning the two prismatic optical blades on the optical path of at least one of the two optical units, the two optical blades (20, 22) forming a harmonizer harmonizing the optical axes of the two optical units.

13. The binoculars according to claim 1, wherein said two optical blades are fixed to each other by gluing.
